(19) United States
(12) Patent Application Publication
(10) Pub. No.: US 2024/0062659 A1
(43) Pub. Date: Feb. 22, 2024

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventor: Kenji KONDO, Tokyo (JP)

(73) Assignee: TOYOTA JIDOSHA KABUSHIKI KAISHA, Toyota-shi (JP)

(21) Appl. No.: 18/222,655

(22) Filed: Jul. 17, 2023

(30) Foreign Application Priority Data
Aug. 17, 2022 (JP) 2022-129842

(51) Int. Cl. G08G 1/00; G06Q 10/0631

(52) U.S. Cl. CPC G08G 1/202; G06Q 10/06315

(57) ABSTRACT

An information processing apparatus, comprises a controller configured to execute: monitoring a plurality of vehicles that provide a predetermined service; identifying standby situations of the plurality of vehicles at each of a plurality of vehicle sites, based on a result of the monitoring; determining a reallocation plan of one or more vehicles during standby at any of the plurality of vehicle sites so that vehicles having predetermined attributes are allocated at predetermined vehicle sites, based on the identified standby situations; and issuing an instruction for movement to a first vehicle site, to a vehicle whose allocation destination vehicle site is changed to the first vehicle site.

### CROSS REFERENCE TO THE RELATED APPLICATION

This application claims the benefit of Japanese Patent Application No. 2022-129842, filed on Aug. 17, 2022, which is hereby incorporated by reference herein in its entirety.

### BACKGROUND

### Technical Field

The present disclosure relates to service providing by a vehicle.

### Description of the Related Art

Systems that allocate vehicles (e.g., vehicles performing passenger transport) in accordance with user demand have been known.

In this respect, for example, Japanese Patent Laid-Open No. 2020-086945 discloses a system where if vehicle shortage occurs in an area for providing a transport service, a vehicle is forwarded from another area for supplement.

### SUMMARY

The present disclosure has an object to supply an appropriate vehicle.

The present disclosure in its one aspect provides an information processing apparatus, comprising a controller configured to execute: monitoring a plurality of vehicles that provide a predetermined service; identifying standby situations of the plurality of vehicles at each of a plurality of vehicle sites, based on a result of the monitoring; determining a reallocation plan of one or more vehicles during standby at any of the plurality of vehicle sites so that vehicles having predetermined attributes are allocated at predetermined vehicle sites, based on the identified standby situations; and issuing an instruction for movement to a first vehicle site, to a vehicle whose allocation destination vehicle site is changed to the first vehicle site.

The present disclosure in its another aspect provides an information processing method, comprising: a step of monitoring a plurality of vehicles that provide a predetermined service; a step of identifying standby situations of the plurality of vehicles at each of a plurality of vehicle sites, based on a result of the monitoring; a step of determining a reallocation plan of one or more vehicles during standby at any of the plurality of vehicle sites so that vehicles having predetermined attributes are allocated at predetermined vehicle sites, based on the identified standby situations; and a step of issuing an instruction for movement to a first vehicle site, to a vehicle whose allocation destination vehicle site is changed to the first vehicle site.

Another aspect is a program for causing a computer to execute the method described above, or a computer-readable storage medium that non-transitorily stores the program.

According to the present disclosure, an appropriate vehicle can be supplied.

### BRIEF DESCRIPTION OF THE DRAWINGS

FIG. 1 is a schematic diagram of a vehicle system according to a first embodiment;

FIG. 2 is a diagram illustrating components of a user apparatus;

FIG. 3 illustrates an example of a service request transmitted from the user apparatus;

FIG. 4 is a diagram illustrating components of a control server;

FIGS. 5A to 5D are diagrams for illustrating operation schedules of vehicles;

FIG. 6 is a diagram for illustrating demand data, and site data;

FIG. 7 illustrates an example of vehicle data collected by the control server;

FIG. 8 is a diagram illustrating a flow of processes of issuing a command for operation to a vehicle 10;

FIG. 9 illustrates an example of an operation command generated by the control server;

FIG. 10 is a diagram for illustrating vehicle reallocation;

FIG. 11 is a diagram illustrating a flow of processes of instructing a reallocation target vehicle to operate;

FIG. 12 is a diagram illustrating components of a vehicle-mounted device;

FIG. 13 is a sequence diagram of processes of transmitting and receiving vehicle data;

FIG. 14 is a sequence diagram of processes of instructing the vehicle to operate, based on a service request;

FIG. 15 is a flowchart of a reallocation process performed by the control server;

FIG. 16 is a diagram illustrating components of a control server according to a second embodiment; and

FIG. 17 is a flowchart of processes executed by a reallocation unit.

### DESCRIPTION OF THE EMBODIMENTS

An on-demand vehicle system that operates vehicles, based on requests by users has been known. In such a system, a server apparatus that manages operation schedules of a plurality of vehicles issues a command for vehicle allocation and operation, based on the requests by the users.

Typically, each vehicle provided for a service stands by at a predetermined vehicle site, and is operated in response to a request. However, in certain areas, time slots and the like, demand for vehicles temporarily increases in some cases. In such cases, any vehicle capable of providing the service is sometimes absent from the vehicle site.

To address this, an attempt for eliminating uneven distribution of vehicles among sites is performed. For example, if demand is predicted to increase in a certain area and in a certain time slot, measures for preliminarily collecting a lot of vehicles at the vehicle sites in this area can be taken.

However, if there are a plurality of services provided by the vehicles, a case where a service desired by a user cannot be provided only by collecting vehicles can occur.

For example, an example is conceivable where a plurality of services, such as a mobile shop service, a passenger transport service, or a package transport service, are selectively provided by autonomous driving vehicles. If demand for the passenger transport is estimated to increase in a certain time period in such an example, the “passenger transport” service cannot be provided even though a mobile shop vehicle is available.

To solve the problem, it is required to adjust allocation of the vehicles among the sites in consideration of attributes that the vehicles have.

An information processing apparatus according to a first aspect of the present disclosure includes a controller configured to execute: monitoring a plurality of vehicles that provide a predetermined service; identifying standby situations of the plurality of vehicles at each of a plurality of vehicle sites, based on a result of the monitoring; determining a reallocation plan of one or more vehicles during standby at any of the plurality of vehicle sites so that vehicles having predetermined attributes are allocated at predetermined vehicle sites, based on the identified standby situations; and issuing an instruction for movement to a first vehicle site, to a vehicle whose allocation destination vehicle site is changed to the first vehicle site.

The predetermined service can encompass, for example, a plurality of services, such as a passenger transport service, a load transport service, a package storage service, and a mobile shop service.

The controller monitors the plurality of vehicles, and generates a plan for reallocating the vehicles, based on their standby situations. The predetermined attributes are attributes of the vehicles that are preferably allocated at certain vehicle sites.

The vehicle monitoring may be performed based on data transmitted from the vehicles, or performed based on commands issued to the vehicles, for example. The monitoring may be performed by sensors or the like provided at the vehicle sites.

For example, the controller detects change in the standby situations of the vehicles by determining “increase or decrease of the number of vehicles at the plurality of vehicle sites” or the like. Triggered by it, a process of generating the reallocation plan is executed.

Note that the trigger described above is only an example. An event other than this may be adopted as a trigger. Accordingly, vehicles having a predetermined attribute can be forwarded so as to be allocated at a predetermined vehicle site.

The relationship between the vehicle site and the predetermined attribute may be determined based on demand by users (consumers). For example, if demand for passenger transport is expected to increase in a certain area, it may be determined to allocate a lot of vehicles having attributes related to the passenger transport at vehicle sites adjacent to the area. The controller may determine one or more predetermined attributes for each of the plurality of vehicle sites.

The predetermined attribute for each vehicle site may be determined at least based on demand of consumers. For example, the controller may acquire demand data that represents the demand for each of the attributes that the vehicles have, with respect to each of a plurality of areas. The demand data may be acquired from an external apparatus, or be generated based on usage performances of services by vehicles.

The controller may associate each of the plurality of vehicle sites with any of the plurality of areas. Accordingly, it may be determined which vehicle site vehicles should be allocated in to meet demand occurring in a certain area.

The number of predetermined attributes associated with a predetermined vehicle site may be two or more. In this case, the controller may determine a vehicle to be instructed to move, based on the priority of each attribute.

Hereinafter, specific embodiments of the present disclosure are described based on the drawings. The hardware configuration, module configuration, functional configuration and the like described in each embodiment is not intended to limit the technical scope of the disclosure only to them unless otherwise described.

### First Embodiment

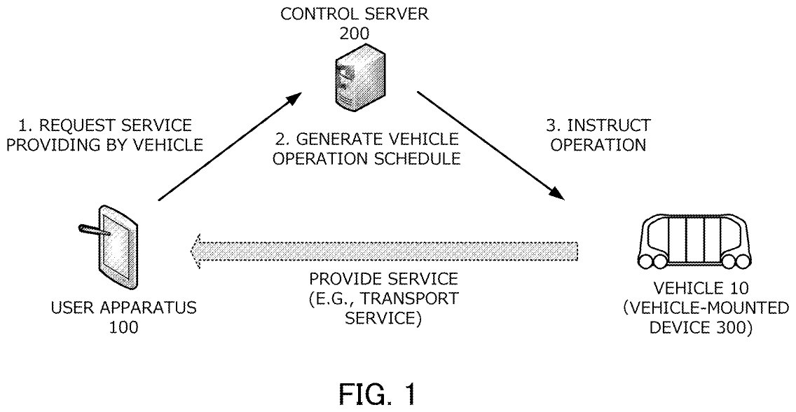

An overview of a vehicle system according to a first embodiment is described with reference to FIG. 1. The vehicle system according to this embodiment is configured to include a vehicle 10 mounted with a vehicle-mounted device 300, a user apparatus 100, and a control server 200. The number of vehicles 10 (vehicle-mounted devices 300) included in the system may be two or more.

The vehicle 10 is an autonomous vehicle that can provide a predetermined service for consumers. Examples of the predetermined service include, for example, passenger transport, package transport, package storage, mobile shop providing, working space providing, and sleeping space providing. The vehicle 10 is configured to be capable of wirelessly communicating with the control server 200 via the vehicle-mounted device 300, and is autonomously operated based on an instruction from the control server 200.

A user intending to use the service by the vehicle 10 transmits a service request to the control server 200 via the user apparatus 100. The service request includes, for example, the type of an intended service (e.g., “taxi”), a point and time at which the vehicle 10 is intended to be dispatched, a destination (in a case where the transport service is intended), and a trade name (in a case where the shop service is intended).

For example, these pieces of information can be generated and transmitted by application software that is installed in the user apparatus 100 and is for using the vehicle system. These pieces of information may be generated using a mobile terminal, or generated using any terminal (a smartphone, a mobile phone, a tablet terminal, a personal digital assistant, or a wearable computer) or a personal computer that is connectable to a network.

The control server 200 generates an operation schedule of the vehicle 10, based on the service request transmitted from the user apparatus 100. The control server 200 includes a database for managing the operation schedules of a plurality of vehicles 10. When the operation schedule of each vehicle 10 is updated, the control server 200 updates the database.

Furthermore, the control server 200 transmits data for commanding each vehicle to operate (hereinafter, an operation command) to the target vehicle 10 (vehicle-mounted device 300), based on the updated operation schedule. The operation command is data for instructing the vehicle 10 to perform a plurality of tasks: for example, “travel to a predetermined point A”, “allow a user to board”, “travel to a predetermined point B”, “allow the user to alight”, and “return to the vehicle site”.

The vehicle-mounted device 300 receives the operation command from the control server 200. In a case where the vehicle 10 is an autonomous vehicle, the operation command is transmitted to a device that is mounted on the vehicle 10 and controls autonomous travel. Note that the vehicle 10 may be a crewed vehicle. In this case, the operation command is provided for a crew via the vehicle-mounted device 300.

In the vehicle system according to this embodiment, a plurality of user apparatuses 100, the control server 200, and vehicle-mounted devices 300 are connected to each other via a network. A WAN (Wide Area Network) that is, for example, a world scale public communication network, such as the Internet, or other communication networks may be adopted as the network. The network may also include a telephone communication network, such as mobile phones, and a wireless communication network, such as Wi-Fi (registered trademark).

Each of the elements that constitute the system are described.

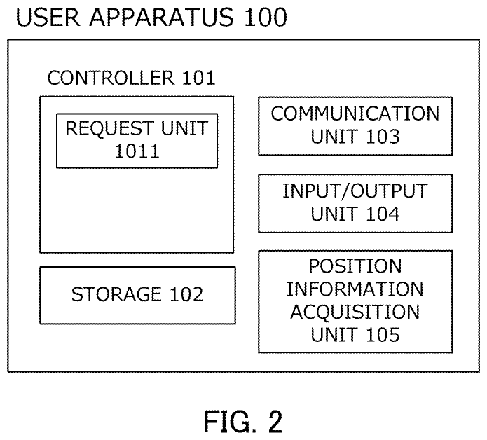

FIG. 2 is a diagram illustrating the system configuration of the user apparatus 100.

The user apparatus 100 is, for example, a small-sized computer, such as a smartphone, a mobile phone, a tablet computer, a personal digital assistant, a notebook computer, or a wearable computer (smart watch etc.). The user apparatus 100 is configured to include a controller 101, a storage 102, a communication unit 103, an input/output unit 104, and a position information acquisition unit 105.

The controller 101 is a computational device that administers control performed by the user apparatus 100. The controller 101 can be achieved by a computation processing device, such as a CPU (Central Processing Unit).

The controller 101 is configured to include a request unit 1011 as a function module. The function module may be achieved by the CPU executing a program stored in the storage 102 described later.

The request unit 1011 acquires, from the user of the apparatus, information required to request the vehicle to provide the service, and transmits the service request including this information to the control server 200.

The service request includes the type of the intended service, and service content. For example, in a case where the intended service is the passenger transport service, an intended boarding point, an intended boarding time, an intended alighting point and the like can be exemplified as the service content. In a case where the intended service is a mobile shop service, the type, identifier, quantity and the like of articles intended to be purchased can be exemplified as the service content. The service content varies depending on the type of the service.

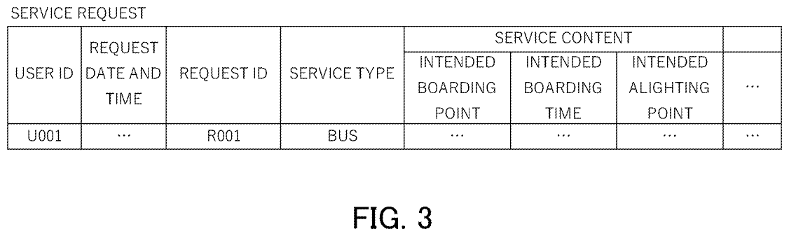

The request unit 1011 acquires these pieces of information via the input/output unit 104 described later. The acquired information is transmitted as the service request to the control server 200. FIG. 3 illustrates an example of the service request generated by the request unit 1011. The request unit 1011 performs a process of confirming a reservation for the vehicle 10, by interaction with the control server 200.

The storage 102 is configured to include a main memory, and an auxiliary storage device. The main memory is a memory where a program to be executed by the controller 101, and data used by the control program are deployed. The auxiliary storage device is a device where a program to be executed by the controller 101, and data used by the control program are stored. The auxiliary storage device may store programs that are to be executed by the controller 101 and are packaged as applications. An operating system for executing the applications may be stored. The programs stored in the auxiliary storage device are loaded into the main memory, and are executed by the controller 101, thus performing processes described later.

The main memory may include a RAM (Random Access Memory), and a ROM (Read Only Memory). The auxiliary storage device may include an EPROM (Erasable Programmable ROM), and a hard disk drive (HDD). Furthermore, the auxiliary storage device may include a removable medium, i.e., a portable recording medium. The removable medium is, for example, a USB (Universal Serial Bus) memory, or a disk recording medium, such as a CD (Compact Disc) or a DVD (Digital Versatile Disc).

The communication unit 103 is a wireless communication interface for connecting the user apparatus 100 to the network. For example, the communication unit 103 provides access to the network, through a wireless LAN, or a mobile communication service, such as 3G, LTE or the like.

The input/output unit 104 is a unit that accepts input operation performed by the user of the apparatus, and presents information. In this embodiment, the input/output unit 104 is made up of one touch panel display. That is, the input/output unit 104 is made up of a liquid crystal display and its control unit, and a touch panel and its control unit.

Next, the configuration of the control server 200 is described.

The control server 200 can be configured as a computer that includes a processor, such as a CPU and a GPU, a main memory, such as a RAM and a ROM, and an auxiliary storage device, such as an EPROM, a hard disk drive, or a removable medium. The auxiliary storage device stores the operating system (OS), various programs, various tables and the like. By executing the programs stored there, each function in conformity with a predetermined purpose as described later can be achieved. Note that part of or the entire function may be achieved by a hardware circuit, such as an ASIC or an FPGA. Note that the control server 200 may be made up of a single computer, or made up of a plurality of computers that cooperate with each other.

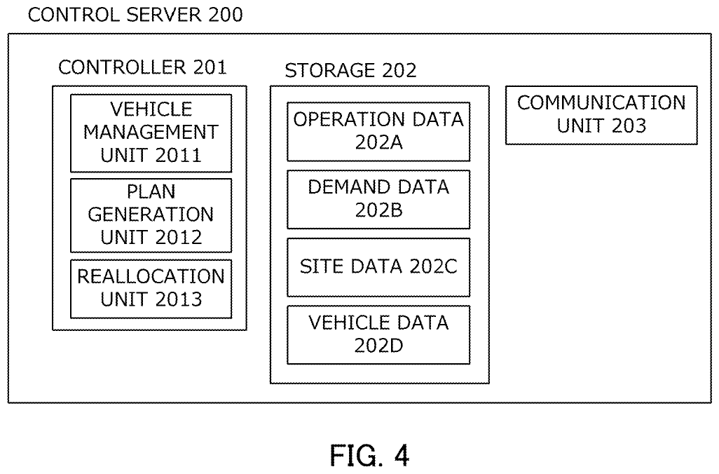

FIG. 4 is a diagram illustrating the system configuration of the control server 200. The control server 200 is configured to include a controller 201, a storage 202, and a communication unit 203.

The controller 201 is a computational device that administers control performed by the control server 200. The controller 201 can be achieved by a computation processing device, such as a CPU.

The controller 201 is configured to include three types of function modules that are a vehicle management unit 2011, a plan generation unit 2012, and a reallocation unit 2013. Each function module may be achieved by executing a program stored in an auxiliary storage unit by the CPU.

The vehicle management unit 2011 updates data for managing the plurality of vehicles 10, based on data received from the vehicles 10 (vehicle-mounted devices 300). In this embodiment, vehicle data is exemplified as the data for managing the plurality of vehicles 10. The vehicle data is data representing the current situation of each vehicle 10 received from this vehicle 10 (described later in description of the storage 202).

The plan generation unit 2012 updates the data for managing the operation schedule of the vehicles 10, based on the service request received from the user apparatus 100. In this embodiment, operation data is exemplified as the data for managing the operation schedule of the vehicles 10. The operation data is a set of the operation schedules of the plurality of vehicles 10 (described later in description of the storage 202).

Specifically, when the service request is transmitted, the plan generation unit 2012 refers to the operation schedule for each vehicle, determines the vehicle 10 that is to provide the service, and updates the operation schedule of this vehicle. After the operation schedule is determined, the plan generation unit 2012 generates the operation command for operating the vehicle 10 according to the operation schedule, and transmits it to the target vehicle 10.

Note that the plan generation unit 2012 can determine occurrence of a delay or the like of the operation of a specific vehicle 10, based on the existing operation schedule, and on data received from the vehicle 10, and regenerate an operation schedule and the like.

On the other hand, when the plurality of vehicles 10 are continuously operated in response to the service requests, the allocation of the plurality of vehicles 10 sometimes becomes uneven. For example, it is conceivable that demand for vehicles performing passenger transport increases in a returning commute time slot around a railway station. As a result of a lot of times of transport originated from the station, the vehicles 10 that can perform passenger transport sometimes become absent around the station. In such a case, even if vehicles 10 having another function (e.g., mobile shop vehicles) are present around the station, the desired service cannot be provided.

To address this, the reallocation unit 2013 reallocates the vehicles 10, based on the demand in each area, and on the attributes of the vehicles 10. The reallocation indicates that vehicles having a predetermined attribute are forwarded to a predetermined vehicle site. The reallocation unit 2013 generates a plan for forwarding the vehicles 10, at timing when each vehicle 10 departs from or enters any vehicle site, and instructs target vehicles 10 to move between the vehicle sites.

The storage 202 is configured to include a main memory, and an auxiliary storage device. The main memory is a memory where a program to be executed by the controller 201, and data used by the control program are deployed. The auxiliary storage device is a device where a program to be executed by the controller 201, and data used by the control program are stored.

The storage 202 stores operation data 202A, demand data 202B, site data 202C, and vehicle data 202D.

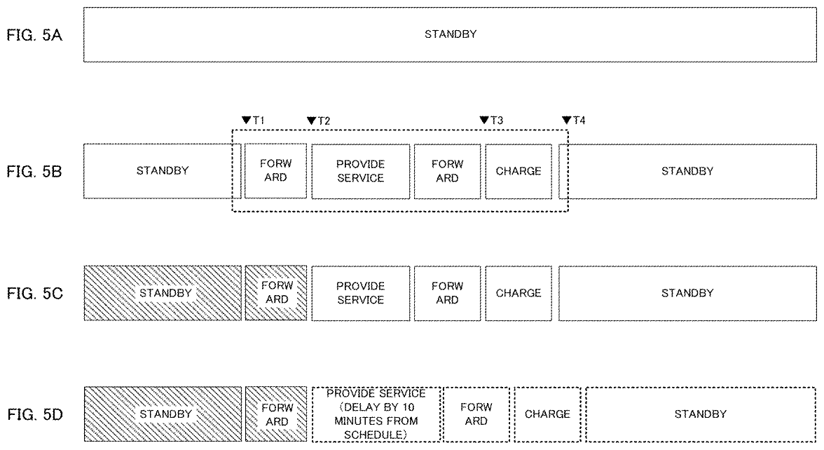

The operation data 202A is data for recording the operation schedules of the plurality of vehicles 10. FIGS. 5A to 5D are diagrams each representing an operation schedule of a certain vehicle 10 represented by the operation data 202A.

FIG. 5A is a diagram illustrating a state where no operation schedule is included with respect to the vehicle 10. In this case, the vehicle 10 is in a standby state at a predetermined vehicle site.

FIG. 5B illustrates an example of an operation schedule updated based on a service request for requesting the transport service. In this example, the vehicle 10 departs from the vehicle site at time T1, and travels toward a designated point. At time T2, a user is picked up, and the transport service is provided. After service providing is finished, the vehicle 10 returns to the vehicle site, and charging is started at time T3. When the charging is finished at time T4, the state becomes the standby state again, thus being in a state capable of responding to another request.

Note that the vehicle site from which the vehicle 10 departs, and the vehicle site to which the vehicle 10 returns may be different from each other. The vehicle site to which the vehicle 10 returns may be dynamically determined based on, for example, the distance from a point where service providing is finished, or parking availability information at the vehicle site.

Note that the operation data 202A may represent a planned operation schedule in the future, or represent the previous operation achievement. For example, hatching in FIG. 5C represents tasks having already been completed.

It can be determined which task has been completed based on the vehicle data received from the vehicle 10 (vehicle-mounted device 300).

The demand data 202B is data defining what demand occurs in areas where services are provided.

The site data 202C is data defining the relationship between the areas and the vehicle sites. The site data 202C includes data indicating how the areas are divided from each other and where vehicle sites reside in them. In other words, the site data 202C is data defining the positional relationship between each area and the vehicle sites.

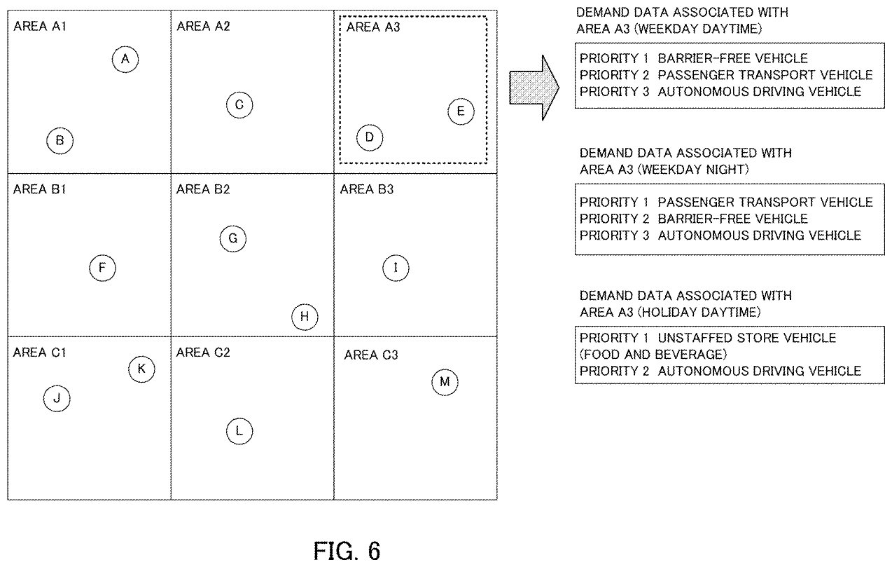

FIG. 6 is a diagram for illustrating the demand data 202B, and the site data 202C. In this example, division is made into nine areas. As illustrated in the diagram, in the site data 202C, a plurality of areas, and the positions of a plurality of vehicle sites are defined. Note that the plurality of vehicle sites defined in the site data 202C may be grouped on an area-by-area basis.

The demand data 202B defines the demand in each area.

For example, in a case where an area A3 is an area where passenger transport by autonomous driving vehicles is legally permitted, it is preferable to allocate autonomous driving vehicles at vehicle sites D and E positioned in the area A3. In a case where a lot of elderly people reside in the area A3, it is preferable to allocate a lot of barrier-free vehicles at the vehicle sites D and E positioned in the area A3.

Thus, the demand data 202B is data representing “which characteristics (attributes) of vehicles 10 the demand resides in each of the plurality of the areas”.

Note that the demand data 202B may be defined with respect to each time slot, each day of week, and each date. In a case where a plurality of types of vehicles are demanded in the same area, the attributes may be assigned priorities.

The vehicle data 202D is a set of vehicle data items received from the vehicles 10 (vehicle-mounted devices 300). As described above, the vehicle data is data indicating the current situation of the vehicle 10.

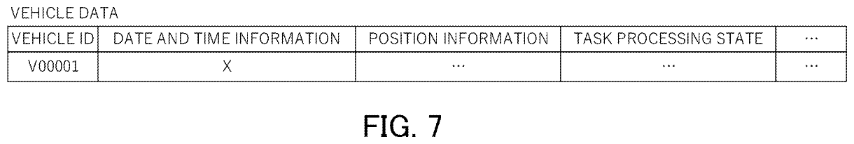

FIG. 7 illustrates an example of the vehicle data. The vehicle data includes an identifier of the vehicle 10, date and time information, position information on the vehicle 10, and data representing the processing state of a task (for example, which task among the plurality of given tasks has been finished, or which is currently in execution). The data representing the processing state of the task may include a delay time period from the planned schedule.

The communication unit 203 is a communication interface for connecting the control server 200 to the network. The communication unit 203 is configured to include, for example, a network interface board, and a wireless communication circuit for wireless communication.

Here, the flow of processes executed by the vehicle management unit 2011, the plan generation unit 2012, and the reallocation unit 2013 described above is described in more detail.

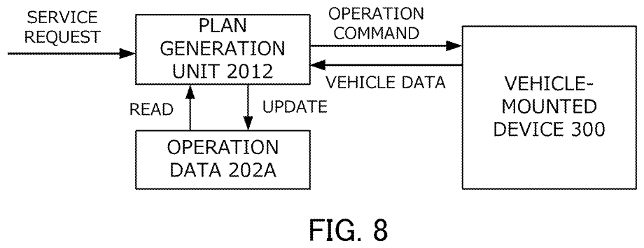

FIG. 8 is a diagram illustrating the flow of processes determining the operation schedule of the vehicle 10, based on the service request, and commanding the vehicle 10 to operate.

The plan generation unit 2012 determines a vehicle 10 that provides the service, based on the service request received from the user apparatus 100. The vehicle 10 that provides the service can be determined based on the operation data 202A. For example, if the requested service is the transport service, the plan generation unit 2012 determines the vehicle 10 to which can be assigned a series of tasks “traveling to a designated point from the vehicle site, providing the transport service, returning to the vehicle site, and being charged”.

If the series of tasks can be assigned, the schedule illustrated in FIG. 5A is updated as in FIG. 5B. When the schedule is determined, the plan generation unit 2012 generates a corresponding operation command, and transmits this operation command to the vehicle-mounted device 300 mounted on the vehicle 10 that is a target.

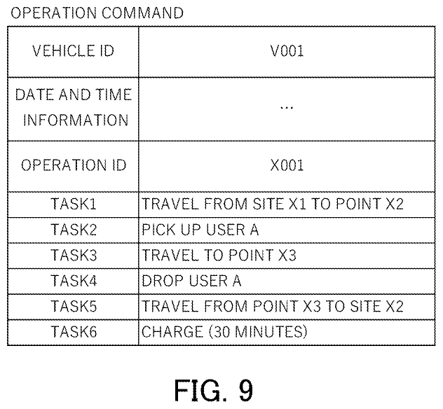

FIG. 9 illustrates an example of the operation command. As illustrated in the diagram, the operation command includes a plurality of tasks to be executed by the vehicle 10. Each task may be associated with a scheduled time, and a deadline time.

Returning to FIG. 8, the description is continued.

The plan generation unit 2012 periodically receives the vehicle data from each vehicle 10 (vehicle-mounted device 300), and updates the operation data 202A based on it.

Specifically, the plan generation unit 2012 executes a process of reflecting the task having already been completed, in the operation data 202A. Accordingly, the schedule illustrated in FIG. 5B is updated to one illustrated in FIG. 5C.

The plan generation unit 2012 detects that the schedule of the vehicle 10 is delayed, and executes a process of rescheduling the operation of the vehicle 10.

For example, it is assumed that in the case in FIG. 5C, the service providing (i.e., passenger transport) is delayed by 10 minutes from the schedule. The delay from the schedule can be determined based on the task processing state included in the vehicle data, for example. In this case, timing of returning to the vehicle site and being brought into the standby state is delayed by 10 minutes. Consequently, the plan generation unit 2012 can regenerate the operation schedule as illustrated in FIG. 5D.

Note that in a case where a subsequent schedule is present and rescheduling is unavailable, the plan generation unit 2012 may notify the system administrator of this.

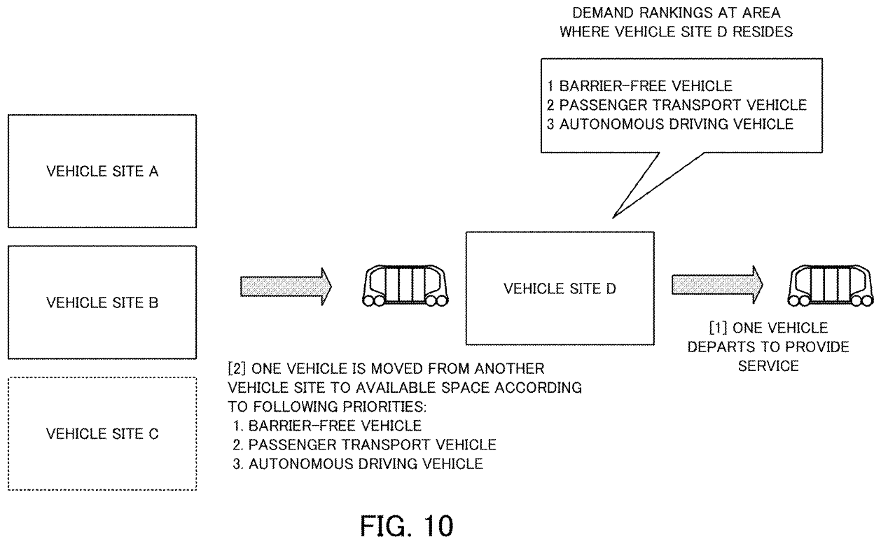

Next, a process by the reallocation unit 2013 relocating the plurality of vehicles 10 based on the attributes of the vehicles 10 is described in more detail. FIG. 10 is a diagram illustrating reallocation of the vehicles 10 among the plurality of vehicle sites.

In this embodiment, at timing when the vehicle 10 enters a certain vehicle site, and at timing when the vehicle 10 departs from the vehicle site, the reallocation of the vehicles 10 is executed. Here, it is assumed that one vehicle 10 departs from the vehicle site D to provide the service.

Upon detection of departure of the vehicle 10 from the vehicle site D, the reallocation unit 2013 determines an attribute with which the vehicle is to be moved to an available parking space at the vehicle site (from another vehicle site), and commands the target vehicle 10 to move.

Note that the departure or entrance of the vehicle 10 may be determined based on the vehicle data transmitted from the vehicle 10, or estimated based on the operation command issued to the vehicle 10. The departure or entrance of the vehicle 10 can also be determined based on sensor data transmitted from the sensor provided at each vehicle site.

In this example, it is assumed that in the area including the vehicle site D, demand is high in an order of “barrier-free vehicle”, “passenger transport vehicle”, and “autonomous driving vehicle”.

In this case, the reallocation unit 2013 determines whether there is any vehicle 10 movable from another vehicle site according to the priorities of “barrier-free vehicle”, “passenger transport vehicle”, and “autonomous driving vehicle”. If there is a movable vehicle 10, the vehicle is instructed to move to the vehicle site D. Accordingly, the vehicles 10 having the attribute with high demand in peripheral areas can be allocated at the vehicle site D.

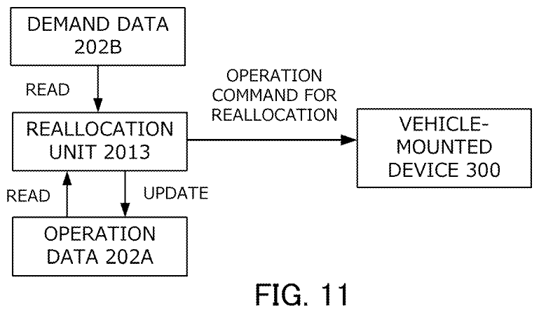

FIG. 11 is a diagram illustrating the flow of processes by the reallocation unit 2013 instructing a reallocation target vehicle to operate.

The reallocation unit 2013 determines which vehicle site the vehicle 10 having the attribute concerned is to be allocated, based on the demand data 202B and the site data 202C. For example, if there is a vehicle attribute with high demand in a certain area, it is determined that vehicles 10 having this attribute are to be allocated at vehicle sites in this area (vehicle sites at a predetermined distance or less from this area).

The reallocation unit 2013 refers to the operation data 202A, determines the movement target vehicle 10, and transmits the operation command to the vehicle 10 concerned.

Next, the configuration of the vehicle-mounted device 300 is described.

The vehicle-mounted device 300 is a computer mounted on the vehicle 10. The vehicle-mounted device 300 exchanges information about the operation by communicating with the control server 200.

The vehicle-mounted device 300 may also serve as a device that provides information for the crew or passengers of the vehicle 10. The vehicle-mounted device 300 may be an electronic control unit (ECU) included in a vehicle platform. The vehicle-mounted device 300 may be a data communication module (DCM) having a communication function.

The vehicle-mounted device 300 has a function of wirelessly communicating with an external network. The vehicle-mounted device 300 may have a function of downloading traffic information, road map data and the like by communicating with the external network.

The vehicle-mounted device 300 can be configured as a computer that includes a processor, such as a CPU and a GPU, a main memory, such as a RAM and a ROM, and an auxiliary storage device, such as an EPROM, a hard disk drive, or a removable medium. The auxiliary storage device stores the operating system (OS), various programs, various tables and the like. By executing the programs stored there, each function in conformity with a predetermined purpose as described later can be achieved. Note that part of or the entire function may be achieved by a hardware circuit, such as an ASIC or an FPGA.

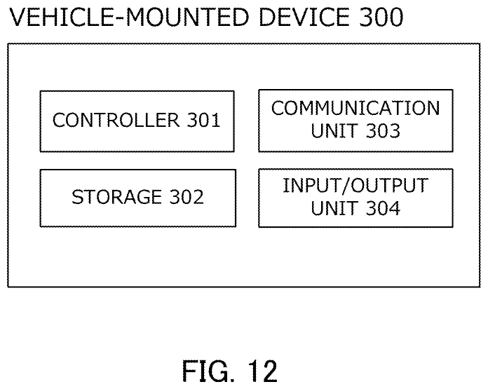

FIG. 12 is a diagram illustrating the components of the vehicle-mounted device 300 in detail.

The vehicle-mounted device 300 is configured to include a controller 301, a storage 302, a communication unit 303, and an input/output unit 304.

The controller 301 is a computational unit that achieves various functions of the vehicle-mounted device 300 by executing predetermined programs. The controller 301 may be achieved by a CPU or the like, for example. The controller 301 may achieve its function by the CPU executing a stored program.

The controller 301 acquires or generates data (vehicle data) about the operation of the vehicle 10 at predetermined timing, and transmits it to the control server 200. The vehicle data includes, for example, position information, and the task processing state. The controller 301 has a function of acquiring the position information via a GPS module or the like.

The storage 302 is a unit that stores information, and is made up of a storage medium, such as a RAM, a magnetic disk, a flash memory or the like. The storage 302 stores various programs to be executed by the controller 301, and data and the like used by the programs.

The communication unit 303 includes an antenna and a communication module for wireless communication. The antenna is an antenna element that performs input and output of wireless signals. In this embodiment, the antenna conforms to mobile communication (e.g., mobile communication of 3G, LTE, 5G or the like). Note that the antenna may be configured to include a plurality of physical antennas. For example, in a case of mobile communication using radio waves in a high-frequency band, such as microwaves, or millimeter waves, the plurality of antennas may be arranged in a distributed manner in order to facilitate communication stabilization. The communication module is a module for performing mobile communication.

The input/output unit 304 is a unit that accepts input operation, and presents information. In this embodiment, the input/output unit 304 is made up of one touch panel display. That is, the input/output unit 304 is made up of a liquid crystal display and its control unit, and a touch panel and its control unit.

Note that the configurations illustrated in FIGS. 2, 4, and 12 are examples. The entire or part of the illustrated function may be achieved using a circuit designed in a dedicated manner. The programs may be stored or executed by a combination of the main memory and the auxiliary storage device that is other than what is illustrated.

Next, the processes executed by each apparatus are described.

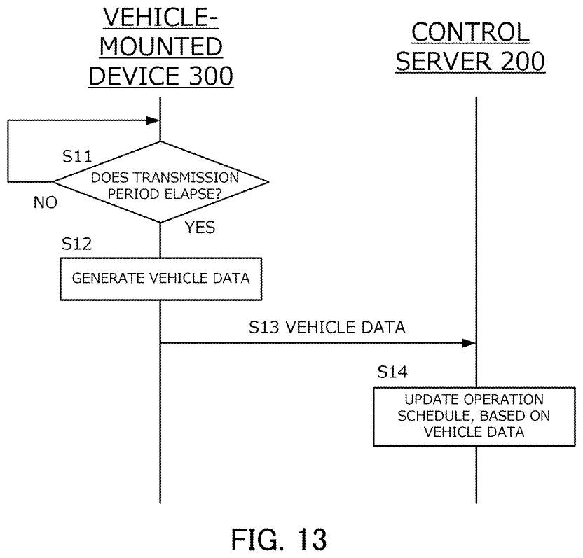

FIG. 13 is a sequence diagram of a process by the vehicle-mounted device 300 and the control server 200 transmitting and receiving the vehicle data. The illustrated process is repeatedly executed by the controller 301 at a predetermined period while the vehicle 10 is traveling.

First, in step S11, the vehicle-mounted device 300 determines whether a predetermined transmission period elapses or not. If the predetermined period (e.g., every one minute) elapses, the processing transitions to step S12. If the predetermined period does not elapse, a predetermined time is waited for, and the process is repeated.

In step S12, the vehicle-mounted device 300 generates the vehicle data. The generated vehicle data is transmitted to the control server 200 in step S13.

In step S14, the control server 200 (vehicle management unit 2011) receives the vehicle data transmitted from the vehicle-mounted device 300, and updates the operation schedule (operation data 202A) of the vehicle 10, based on the vehicle data.

Note that in this example, it is assumed that the vehicle-mounted device 300 transmits the vehicle data at a predetermined period. Alternatively, transmission of the vehicle data may be performed only at timing of occurrence of a predetermined event. For example, timing when the vehicle 10 starts a new task, timing when the task in execution is completed by the vehicle 10, and timing when the vehicle 10 reaches a predetermined spot can be exemplified as such timing.

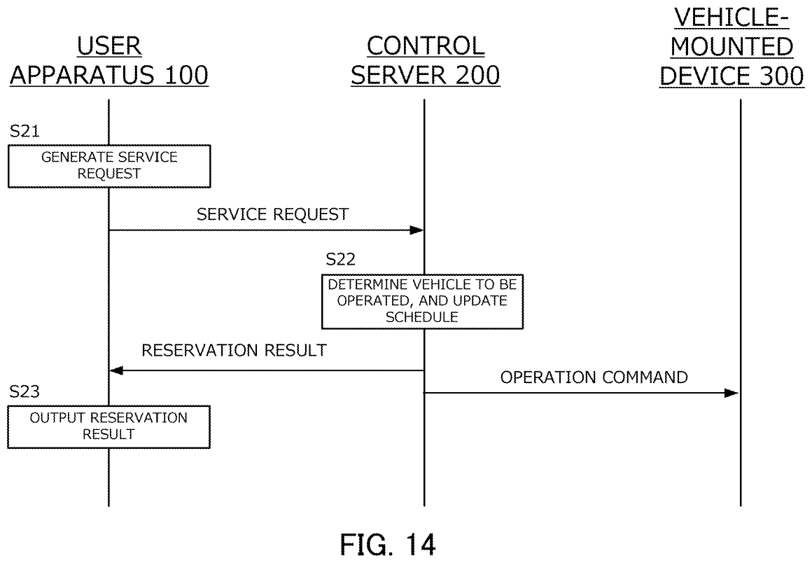

FIG. 14 is a sequence diagram of processes by the control server 200 accepting the service request. The illustrated processes are started based on operation by the user.

First, in step S21, the user apparatus 100 (request unit 1011) generates the service request. In this step, the user is allowed to input the service to be requested, and data about its content, through a predetermined interface.

The service request includes the type of the intended service, and service content. For example, in a case where the intended service is the passenger transport service, an intended boarding point, an intended boarding time, an intended alighting point and the like can be exemplified as the service content. In a case where the intended service is a mobile shop service, the type, identifier, quantity and the like of articles intended to be purchased can be exemplified as the service content.

The request unit 1011 transmits the generated service request to the control server 200 (plan generation unit 2012).

In step S22, the control server 200 (plan generation unit 2012) determines the vehicle 10 that provides the service, based on the operation data 202A, and generates its operation schedule. The vehicle 10 that provides the service can be determined based on a time period required to provide the requested service, and on the attribute of the vehicle 10. When the operation schedule is determined, the plan generation unit 2012 generates a corresponding operation command, and transmits the operation command to the vehicle-mounted device 300 mounted on the vehicle 10 that is a target. The plan generation unit 2012 transmits a reservation result to the user apparatus 100, and the request unit 1011 outputs it (step S23). Accordingly, the user can confirm that the reservation for the vehicle 10 is established.

The vehicle-mounted device 300 transmits the operation command to a device that controls autonomous travel, or provides it for the crew. Accordingly, the operation of the vehicle 10 is started.

Next, a method by the control server 200 (reallocation unit 2013) adjusting the allocation of the plurality of vehicles 10 at the plurality of vehicle sites.

As described above, with the vehicle system according to this embodiment, the vehicle 10 is operated based on the service request. Note that the vehicle 10 that has finished the service does not necessarily return to the vehicle site of the departure. That is, as time elapses, uneven allocation of vehicles possibly occurs. The reallocation unit 2013 periodically executes a process to resolve this.

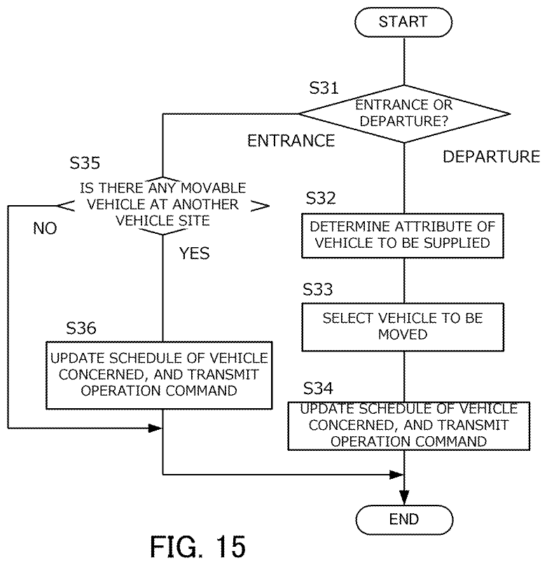

FIG. 15 is a flowchart of processes executed by the reallocation unit 2013. The illustrated processes are executed when the vehicle 10 enters any of the plurality of vehicle sites, or the vehicle 10 departs from any of the plurality of vehicle sites. The fact the vehicle 10 enters the vehicle site or departs from the vehicle site can be determined based on the vehicle data received from the vehicle-mounted device 300, for example.

First, in step S31, it is determined which one occurs between departure and entrance. If the occurring event is departure, the process transitions to step S32. If the occurring event is entrance, the process transitions to step S35.

In step S32, the attribute of the vehicle to be supplied instead of the vehicle 10 having departed is determined. The vehicle having the attribute concerned can be determined by the following processes.
(1) The area associated with the target vehicle site is identified.

For example, among the plurality of predefined areas, the area nearest to the target vehicle site (hereinafter, a first area) is identified. The process can be performed based on data (site data 202C) defining the positional relationship between the areas and the vehicle sites. Note that the area identification is not necessarily performed based on a direct linear distance.
(2) Based on demand in the first area, the vehicle attribute is determined.

For example, the demand data 202B is referred to, and it is determined which attribute of the vehicle the demand resides in. Note that the number of types of demand determined here is not necessarily one. For example, it may be determined that demand for barrier-free vehicles is the highest, demand for passenger transport vehicles is the second highest, and demand for autonomous driving vehicles is subsequently high.

Next, in step S33, the vehicle 10 having the determined attribute is selected.

In this step, for example, it is determined whether the vehicle 10 having the determined attribute can be forwarded from another vehicle site or not. The other vehicle site is a vehicle site at a place farther than the processing target vehicle site from the first area. This is because if the target vehicle is at a place nearer to the first area than the processing target vehicle site, there is no advantage of forwarding the vehicle.

It can be determined whether the vehicle 10 having a certain attribute can be forwarded between vehicle sites, based on the operation data 202A. For example, if the travel requires 15 minutes between certain vehicle sites, the vehicle 10 that has the determined attribute, and an available schedule for 15 minutes or longer is selected.

Note that if the attributes determined in step S32 are of two or more types, the vehicle 10 may be selected based on their priorities. For example, first, the barrier-free vehicle is tried to be forwarded, and if no schedule can be established, a passenger transport vehicle may then be tried to be forwarded.

In step S34, the operation schedule of the selected vehicle 10 is updated, the operation command for forwarding between the vehicle sites is then generated, and is transmitted to the vehicle 10. Accordingly, the vehicle 10 having the predetermined attribute (the attribute with high demand in adjacent areas) can be brought to the target vehicle site (i.e., the vehicle site where the number of vehicles decreased by one).

If the event occurring in step S31 is entrance, the process transitions to step S35.

In step S35, it is determined whether there is any vehicle movable to another vehicle site or not. That is, it is determined whether any vehicle 10 having the attribute with high demand can be provided at another vehicle site or not.

In this step, for example, for each of the plurality of vehicles 10 during standby at the target vehicle site, it is determined “whether the vehicle has the attribute with high demand in areas adjacent to the other vehicle site” and “whether forwarding to the other vehicle site is available”. The determination can be performed based on the operation data 202A, the demand data 202B, and the site data 202C. Note that it may be determined whether the other vehicle site has an available parking capacity or not based on parking availability information at the other vehicle site.

Here, if there are a plurality of movable vehicles 10, the vehicle 10 to be forwarded may be determined based on the priority. The priority may be determined based on the magnitude of demand, the distance between the vehicle sites or the like. For example, the vehicle 10 having an attribute with higher demand, and a shorter forwarding distance may be selected.

If there is any movable vehicle 10, the process transitions to step S36. If there is no movable vehicle 10, the process is finished.

In step S36, the operation schedule of the movement target vehicle 10 is updated, the operation command for forwarding between the vehicle sites is generated, and is transmitted to the vehicle 10. Accordingly, the vehicle 10 having the predetermined attribute (the attribute with high demand in adjacent areas) can be forwarded to the target vehicle site.

The processes illustrated in FIG. 15 are repetitively executed at timing when the vehicle 10 enters or departs from the vehicle site. Accordingly, the vehicles 10 having the attribute with high demand in peripheral areas can be gradually accumulated to the predetermined vehicle site.

Note that in this example, the vehicle reallocation is performed triggered by entrance and departure of the vehicle 10. Alternatively, vehicle reallocation may be executed at another timing only if it is based on the standby situations of the vehicles 10 at the plurality of vehicle sites.

In this example, the vehicles 10 are moved on a one-by-one basis. Alternatively, only if the parking capacities at the vehicle sites are available, a plurality of vehicles may be collectively moved.

Furthermore, at predetermined timing (e.g., once a day, once a week or the like), reallocation may be executed for all the vehicles 10.

As described above, in the vehicle system according to the first embodiment, in consideration of the attributes of the vehicles 10, the forwarding schedules of the vehicles 10 between the vehicle sites are generated. Accordingly, the vehicles 10 having the attribute with higher demand can be accumulated to a predetermined vehicle site.

Note that in the first embodiment, it is assumed that the demand data 202B is predefined data. The demand data 202B may be updated as needed based on information from the outside. In this case, at timing when the demand data 202B is updated, the control server 200 may redetermine the allocation of the vehicles 10 at the plurality of vehicle sites.

### Second Embodiment

According to the first embodiment, the attribute of the vehicle 10 to be moved is determined based on the predefined demand data 202B. Unlike this, a second embodiment is an embodiment where the demand data 202B is generated and updated based on a history of the user previously receiving services by vehicles 10.

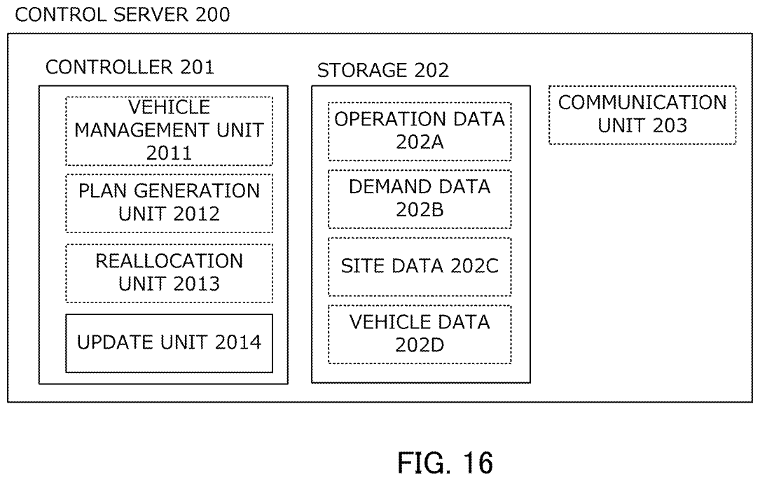

FIG. 16 is a system configuration diagram of a control server 200 according to the second embodiment. In the second embodiment, the control server 200 is configured to further include an update unit 2014.

The update unit 2014 collects a history about services received in a predetermined time period in the past by a user of the system, based on accumulated operation data 202A, and generates demand data 202B on an area-by-area basis, based on the history.

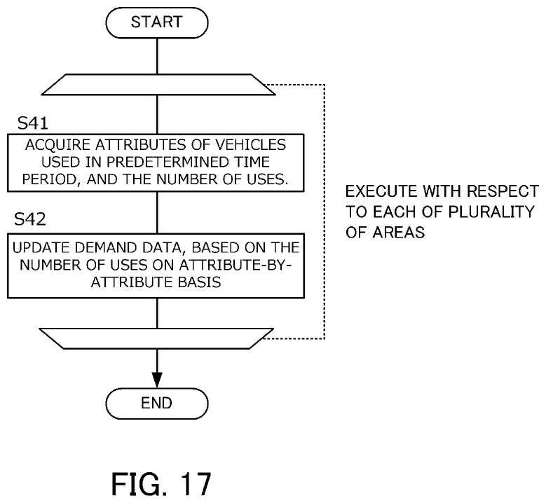

FIG. 17 is a flowchart of processes executed by the update unit 2014 according to the second embodiment. The illustrated processes are executed at predetermined period.

Processes in steps S41 and S42 are executed for each of the plurality of areas that are targets of the system.

First, in step S41, the operation data 202A in a predetermined previous time period (e.g., one month) is referred to, and the attributes (service types) of vehicles 10 used in the predetermined time period, and the number of their uses are acquired. Thus, rankings about the attributes of vehicles used in the target area can be acquired.

Next, in step S42, based on the number of uses on an attribute-by-attribute basis, demand data associated with the area concerned is generated. For example, if the attribute with the highest number of uses is “passenger transport vehicle”, and subsequently “barrier-free vehicle”, and “autonomous driving vehicle”, the attribute with highest demand in this area can be determined as the passenger transport vehicle. The demand data may be what represents the vehicle attributes with high demand in a ranking form, or what associates scores representing the magnitude of demand with the respective vehicle attributes. A score representing the magnitude of demand may be calculated based on the number of uses of vehicles 10 in the past, for example.

Note that if the demand data 202B has already been generated, the update unit 2014 may overwrite the result, or calculate an arithmetic average or the like with previously generated scores and the like and adopt the result as new demand data 202B.

### Modification Example of Second Embodiment

In the second embodiment, the update unit 2014 determines the magnitude of demand, based on the number of uses of vehicles 10 in the past. Another method may be used only if it can determine the magnitude of demand for each vehicle attribute. For example, the relationships between the attributes of vehicles 10, the characteristics of areas, time slots, the number of uses, use time periods, the sales amount may be learned by a machine learning model, and demand data 202B may be generated using this machine learning model.

Data input into the machine learning model is not necessarily about performances of services provided by the vehicles 10. For example, statistical data about consumers in each area, or user information, position information, purchase information or the like transmitted from the user apparatuses 100.

### Other Modification Examples

The embodiments described above are only examples. The present disclosure can be appropriately changed and implemented in a scope without departing from the gist.

For example, the processes and units described in this disclosure can be freely combined and implemented unless any technical contradiction occurs.

In the description of the embodiments, the barrier-free vehicle, the autonomous driving vehicle, and the passenger transport vehicle are exemplified as the attributes that the vehicles have. Alternatively, only if appropriate services can be provided, vehicles having other attributes may be allocated. For example, at vehicle sites adjacent to areas where a trouble for autonomous driving can occur, manually drivable vehicles may be preferentially allocated. At vehicle sites adjacent to areas with high demand for certain articles or services, mobile shop vehicles that can provide the articles or services may be preferentially allocated.

Processing described as being performed by one apparatus may be shared and executed by a plurality of apparatuses. Or alternatively, processing described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors that the computer has reading out and executing the program. Such a computer program may be provided for the computer by a non-transitory computer-readable storage medium connectable to a system bus of the computer or may be provided for the computer via a network. As the non-transitory computer-readable storage medium, for example, a disk of a given type such as a magnetic disk (a Floppy® disk, a hard disk drive (HDD) and the like) and an optical disc (a CD-ROM, a DVD disc, a Blu-ray disc and the like), a read-only memory (ROM), a random-access memory (RAM), an EPROM, an EEPROM, a magnetic card, a flash memory, an optical card, and a medium of a given type that is appropriate for storing electronic commands are included.

What is claimed is:

1. An information processing apparatus, comprising a controller configured to execute:
monitoring a plurality of vehicles that provide a predetermined service;
identifying standby situations of the plurality of vehicles at each of a plurality of vehicle sites, based on a result of the monitoring;
determining a reallocation plan of one or more vehicles during standby at any of the plurality of vehicle sites so that vehicles having predetermined attributes are allocated at predetermined vehicle sites, based on the identified standby situations; and
issuing an instruction for movement to a first vehicle site, to a vehicle whose allocation destination vehicle site is changed to the first vehicle site.

2. The information processing apparatus according to claim 1, wherein
the identifying the standby situations includes detecting that any of the plurality of vehicles departs from any of the plurality of vehicle sites, or enters any of the plurality of vehicle sites, based on a result of the monitoring, and
when the departing or entering is detected, the controller determines the reallocation plan.

3. The information processing apparatus according to claim 2, wherein
the controller determines the predetermined attributes for each of the plurality of vehicle sites.

4. The information processing apparatus according to claim 2, wherein
the controller determines the predetermined attributes associated with each of the plurality of vehicle sites, at least based on demand of consumers.

5. The information processing apparatus according to claim 4, wherein
the controller acquires demand data that represents the demand of the consumers.

6. The information processing apparatus according to claim 5, wherein
the demand data is data that represents the demand for each of the attributes that the vehicles have, with respect to each of a plurality of areas.

7. The information processing apparatus according to claim 6, further comprising
a storage configured to store data that associates each of the plurality of vehicle sites with any of the plurality of areas, wherein
the controller determines the predetermined attributes associated with the respective vehicle sites associated with a first area, based on the demand data in the first area.

8. The information processing apparatus according to claim 6, wherein
the demand data is generated, based on a usage performance of the service by the consumers.

9. The information processing apparatus according to claim 1, wherein
when the number of predetermined attributes associated with the predetermined vehicle sites is two or more, the controller determines the vehicle instructed for the movement, based on priorities for the respective attributes.

10. The information processing apparatus according to claim 9, wherein
the priorities for the respective attributes are generated, based on a usage performance of the service by consumers.

11. An information processing method, comprising:
a step of monitoring a plurality of vehicles that provide a predetermined service;
a step of identifying standby situations of the plurality of vehicles at each of a plurality of vehicle sites, based on a result of the monitoring;
a step of determining a reallocation plan of one or more vehicles during standby at any of the plurality of vehicle sites so that vehicles having predetermined attributes are allocated at predetermined vehicle sites, based on the identified standby situations; and
a step of issuing an instruction for movement to a first vehicle site, to a vehicle whose allocation destination vehicle site is changed to the first vehicle site.

12. The information processing method according to claim 11, wherein
the step of identifying the standby situations includes a step of detecting that any of the plurality of vehicles departs from any of the plurality of vehicle sites, or enters any of the plurality of vehicle sites, based on a result of the monitoring, and
when the departing or entering is detected, the reallocation plan is determined.

13. The information processing method according to claim 12, further comprising
a step of determining the predetermined attributes for each of the plurality of vehicle sites.

14. The information processing method according to claim 12, wherein
the predetermined attributes associated with each of the plurality of vehicle sites are determined at least based on demand of consumers.

15. The information processing method according to claim 14, further comprising
a step of acquiring demand data that represents the demand of the consumers.

16. The information processing method according to claim 15, wherein
the demand data is data that represents the demand for each of the attributes that the vehicles have, with respect to each of a plurality of areas.

17. The information processing method according to claim 16, further comprising
a step of acquiring data that associates each of the plurality of vehicle sites with any of the plurality of areas, wherein
the predetermined attributes associated with the respective vehicle sites associated with a first area are determined based on the demand data in the first area.

18. The information processing method according to claim 16, wherein
the demand data is generated, based on a usage performance of the service by the consumers.

19. The information processing method according to claim 11, wherein
when the number of predetermined attributes associated with the predetermined vehicle sites is two or more, the vehicle instructed for the movement is determined based on priorities for the respective attributes.

20. The information processing method according to claim 19, wherein
the priorities for the respective attributes are generated, based on a usage performance of the service by the consumers.
